(19) United States
(12) Patent Application Publication
(10) Pub. No.: US 2007/0062171 A1
(43) Pub. Date: Mar. 22, 2007

(54) Insect control system

(76) Inventor: Marilyn Lee Roberts, Kaslo (CA)

Correspondence Address: ANTONY C. EDWARDS, SUITE 200 - 270 HIGHWAY 33 WEST, KELOWNA, BC, V1X 1X7, CA

(21) Appl. No.: 11/521,345

(22) Filed: Sep. 15, 2006

Related U.S. Application Data
(60) Provisional application No. 60/717,038, filed on Sep. 15, 2005.

(51) Int. Cl. A01D 46/24

(52) U.S. Cl. 56/339

(57) ABSTRACT

A control system for reducing or minimizing the damage to fruit and vegetable crops which occurs as a result of insects attacking the fruit or vegetables prior to it being harvested. It includes a bag, ground cover and method for using the same.

### CROSS REFERENCE TO RELATED APPLICATION

This application claims priority from U.S. Provisional Patent Application No. 60/717,038 filed Sep. 15, 2005 entitled Method of Preventing Damage to Cherries and Other Produce without the Use of Poison or Other Spray.

### FIELD OF THE INVENTION

This invention relates to the field of crop bearing plant protection and, in particular, to a method and apparatus for reducing or eliminating damage to fruit and vegetable crops by insects.

### BACKGROUND OF THE INVENTION

Each year, the fruit on fruit bearing trees such as cherries suffer damage from insects which can render such fruit inedible or cause sufficient harm such that the use and appearance of the fruit is significantly reduced. For the individual who cultivates fruit trees for personal use, the damage to fruit caused by insects is disappointing. For orchardists whose livelihood is dependant upon the harvesting of fruit which is both fit for human consumption and aesthetically appealing to the end consumer, such damage may translate into a reduction in or loss of revenue.

The following excerpt from the University of Washington Entomology Department website at http://entomology.tfrec.wsu.edu/Impact/CherryFruitFly.html summarizes the life cycle of one such common fruit pest, the cherry fruit fly.
Cherry fruit fly completes only one generation per year. It overwinters as a pupa in the soil. The pupae are affected by soil temperature and do not all develop at the same rate. Adults begin to emerge in May, about five weeks before harvest, and are active until three or four weeks after harvest. Peak emergence often coincides with harvest.
Adults live 16 to 35 days, depending on temperatures. They feed on deposits on the leaves, such as honeydew and pollen. Adult females undergo a 7- to 10-day pre-oviposition period before they are sexually mature. After mating, they lay eggs under the skin of the fruit. Females frequently feed on juices exuding from the puncture made during egg laying.
Each female can lay from 50 to 200 eggs in a three-week period. The optimum temperature for egg laying is between 75 and 85° F. The eggs hatch in five to eight days, and the larvae burrow towards the pit of the fruit where they cannot be controlled by most insecticides. When fully developed, 10 to 21 days after hatching, larvae bore out of the cherry and drop to the ground. Within a few hours they burrow into the soil to pupate. The majority of the pupae develop into adults the following season, although a few may remain dormant for two years.

Fruit Injury
Adults do no damage to fruit. Maggots, which develop inside the cherries, make the fruit unmarketable. In unsprayed trees a high percentage of fruit is likely to be attacked. The adult cherry fruit fly does not fly long distances so some unsprayed trees may remain uninfested for many years.

Efforts to prevent or reduce the damage to fruit and vegetables caused by insects traditionally involve the use of pesticides, which pesticides may have a negative impact on the environment and on the individuals applying the same to the trees. Such chemicals may also leave a residue on the fruit or vegetables which may not be removed by washing or peeling and which may, consequently, be ingested by the end consumer.

Hence, there is a need for and it is an object of the present invention to provide an alternative means to reduce or eliminate the damage caused by insects to fruit and vegetable crops before such crops are harvested.

### SUMMARY OF THE INVENTION

The present invention is a control system for reducing, minimizing or eliminating the damage to fruit and vegetable crops which occurs as a result of insects attacking the fruit or vegetables prior to it being harvested. It includes a bag, ground cover and method for using the same.

The bag may be made of any suitable porous, pliable material such as, without intending to be limiting, “no-see-um” or mosquito netting, and may be assembled by attaching together any number of pieces of suitable material so as to form a cross (+) shape. The material of which the bag is made must be sufficiently sheer such that when the bag is, for example, placed over a tree, light can penetrate through the bag and shine on the leaves of the tree but must, at the same time, have a mesh or weave which is sufficiently fine so as to keep but insects. The size of the bag and, consequently, of its constituent parts, will be dictated by the size of the plant or tree over which it is intended to be placed.

In one embodiment of the present invention, the bag is made by joining together three appropriately sized pieces of suitable material, A, B and C, which pieces may, in turn, be comprised of smaller pieces of material which have been joined together to form pieces A. B and C. The center piece of material, A, may be rectangular in shape. Perpendicularly and centrally joined to the center piece and oppositely disposed one to the other, are two further pieces, B and C, which are substantially square in shape. The joining of the pieces A, B and C in the manner aforesaid creates a cross-shaped piece of material. The perpendicularly positioned arms respectively created by the joining of piece A to piece B, and the by the joining of piece A to piece C, are then joined together for a seam which is slightly shorter in length than the respective lengths of pieces B and C. Any suitable means of attachment may be utilized such as, without intending to be limiting, sewing. The joining together of pieces A, B and C in the manner aforesaid results in a cube-shaped bag which, when inverted, is open on the bottom end.

The inverted bag is then placed over, for example, the subject tree such that the centre point of the upwardly facing side of the bag is roughly situated at the vertex of the tree. The tree is thus substantially encased by the bag. Any suitable means may be used to place or urge the bag over the tree such as, for example, by utilizing three or four people using long poles, fitted with cushioned end pieces so as to not tear the bag, which are positioned on the upper, inside corners of the bag. The poles are used to lift the bag sufficiently high so that its bottom, open end is placed over the top of the tree, centered and lowered into position over the tree. Once the bag has been placed over the tree, it may be secured at its bottom, open end to the tree trunk by any suitable means such as, without intending to be limiting, tying a rope around the bag and the tree trunk, or by sewing or tying ends of the bag together around the tree trunk. Such securing of the bag to the tree will inhibit the unintended dislodgement of the bag from the tree. Once it has been placed over the tree and secured around the tree trunk, the bag will impede or prevent flies from accessing the tree and any fruit growing thereon.

When it is time to pick the fruit on the tree, the bag can be left in place until the harvesting has been completed, or may be removed prior to picking and stored for reuse. The bag may, without intending to be limiting, be removed by two or more people using poles to lift the bag up and off of the tree or, alternatively, by pulling the bag and sliding it off of the tree.

In a further embodiment of the present invention, the bag is made substantially as in the first embodiment and is fitted with a ribbon and Velcro™ fasteners which are attached by any suitable means to either piece B or C of the bag. For example, without intending to be limiting, on the inside of the bag, two ribbons may be advantageously positioned and attached to piece B of the bag such that the top of each ribbon is joined to pieces A and B along the seam where pieces A and B abut. Two loop-side pieces of two hook-and-loop fasteners, such as Velcro™ fasteners, are then attached to each ribbon and positioned below the seam where pieces A and B, and the top of the ribbons, have been joined. On the opposite side of piece B, the two corresponding hook-side pieces of the Velcro™ fasteners are attached to piece B and the corresponding upper portion of each ribbon at the seam where pieces A and B abut and have been joined with the ribbons. The perpendicularly positioned arms created by the joining together of pieces A, B and C are joined together such that the joining seam extends the full length of each of the four arms created on piece C.

Prior to placing the bag over tree, the lower portion of the material comprising piece B is gathered on top of the two ribbons and the hook-side pieces of the Velcro™ tabs are joined with their corresponding loop-side counterparts. The material comprising piece B is thus held by the ribbons in the downwardly extending loop shape which is created and held in position by the mating of the Velcro™ tabs. The gathering of material B by the ribbon and Velcro™ system creates an opening or window into the interior of the bag thereby facilitating placement of the bag over the tree. Any suitable means may then be used to place the bag over the tree such as, without intending to be limiting, the utilization of long poles positioned in each of the bag corners to lift the bag up and over the tree. Once the top, upward facing, panel of the bag is roughly centered over the top of the tree, the bottom of the ribbons can be pulled which causes the mated Velcro™ pieces to disconnect and allows piece B to drop downward into place for securing around the tree trunk.

To deter and interrupt the life cycle of insects which spend a portion of their life cycles in or on the ground situated beneath a crop bearing plant, a ground cover according to the present invention may be used independently or in conjunction with the bag of the present invention. The ground cover should be made of a suitable transparent or translucent material such as, without intending to be limiting, clear plastic, mosquito netting or “no-see-um” netting. If netting is used, it should have a weave or mesh which is sufficiently fine so as to prevent small insects from passing through it. The ground cover may be of any suitable shape provided that at its narrowest points, it exceeds the diameter of the penumbra of the subject tree by an appropriate distance so as to allow for the wind-blown trajectory of any insect larvae falling from that tree. The ground cover may be made of at least one piece of suitable material. To facilitate placement of the ground cover around the tree trunk, a suitably sized hole may be cut in or near the centre of the ground cover such that there is minimal or no gap between the tree trunk and the ground cover material. A slit may then be cut into the ground cover from the center hole to the outer edge of the ground cover to facilitate placement of the ground cover around tree trunk. The material bounding the slit in the ground cover should be positioned such that they will overlap so that no ground is visible between the slit edges. Alternatively, the ground cover may be comprised of two or more pieces which, when assembled, create a center hole which snugly encircles the tree trunk with no ground visible through any joins and which have total diameter which exceeds the penumbra of the tree by an appropriate distance so as to allow for the wind-blown trajectory of any insect larvae falling from that tree. The ground cover may be secured to the ground by any suitable means of attachment such as, without intending to be limiting, nails or spikes, which are driven downwardly through the ground cover into the ground. If the ground cover is made of a waterproof material such as plastic, the attachment means may be made of a hollow, perforated material such as PVC which could provide a means of drainage for any water accumulating on the ground cover. To reduce the likelihood of the ground cover tearing at the point where it is punctured by the attachment means, a piece of tear-resistant material such as, without intending to be limiting, heavy plastic or cardboard, could be placed between the attachment means and the ground cover.

Utilization of the bag and ground cover of the present invention either alone or in conjunction with each other may interrupt the life cycle of certain insects which attack fruit or vegetable crops to a sufficient degree that the resultant damage to the crops is either significantly reduced or eliminated. Consistent usage of the method and apparatus of the present invention may also substantially eliminate the existence of problem insects in the area near, on and around the crop bearing plant. For example, without intending to be limiting, in the instance of a cherry tree which has been infested by cherry fruit flies, the bag and ground cover of the present invention may be utilized either alone or in conjunction to minimize or eliminate damage to the developing cherry crop. As noted above, where a cherry tree has been infested by the cherry fruit fly, eggs hatch in the developing cherry fruit and, once fully developed, the larvae bore out of the cherry and drop to the ground beneath the cherry tree. Shortly after falling to the ground, the larvae burrow into the ground to pupate and remain in the soil over the winter. The larvae pupate over winter and emerge from the ground as adult flies in the spring, which adult flies then fly up into the cherry tree to lay eggs in the developing cherries.

To interrupt the life cycle of the cherry fruit fly, the ground cover of the present invention may be placed beneath the infested tree in early spring, well prior to the earliest date on which the first adult cherry flies are likely to emerge, and left in place until all of the fruit has been removed from the tree. Access to the cherry tree will be inhibited by the ground cover such that the majority of the adult cherry flies emerging from the ground beneath the ground cover, unable to escape its confines or to reach the developing cherries, will perish under the ground cover without laying eggs. The ground cover will also function as a barrier between any cherry fruit fly larvae falling from fruit on the tree and the ground beneath the tree. By preventing such larvae from reaching the ground which they require in order to survive the winter and to pupate, the life cycle of the cherry fruit fly is further interrupted.

Where the ground cover of the present invention is not used or is used as an additional protective measure, the bag of the present invention may also be used. The bag should be placed over the tree once the fruit has pollinated but prior to, for example, the cherry fruit fly laying its eggs. Without intending to be limiting, to establish an indicator as to the appropriate time to place the bag on the tree, Safer's Sticky Strips™ or a similar product may be hung on the subject tree. Once the first fruit fly is seen on the strip, the bag should be placed over the tree. The barrier created by the bag will inhibit or prevent adult fruit flies from accessing the fruit developing on the tree thereby preventing the adult flies from laying eggs in or on that fruit. The likelihood of the fruit being infested with fruit fly larvae is therefore significantly reduced. This translates to a reduction in the number of fruit fly larvae which can develop while at the same time preserving the quality of the developing fruit. Once all of the fruit has been harvested or removed from the tree, the bag can be removed.

In summary then, the present invention may be summarized in one aspect as an insect control system for mounting on a tree to control infestation of the tree by target insects, where the system includes at least a tree foliage containment bag. The bag is of porous flexible mesh material having apertures smaller than the target insects to inhibit passage of the target insects through said mesh. The bag, when laid flat, in planform is shaped to include a radially spaced apart array of planar arms extending from a center portion. The center portion corresponds to a top portion of said bag once assembled and mounted atop the tree. The array of arms corresponds to side portions of said bag once assembled and mounted so as to cover sides of the tree. The arms each include side edges therealong whereby, opposed obliquely facing side edges on adjacent pairs of arms are mountable to each other to form a closed seam along and between each of the pairs of arms. The bag thus formed is a flexible porous three dimensional container mountable over the tree so as to substantially entirely cover the limbs and foliage of the tree. Means are provided for securing lower edges of the array of arms when mounted on the tree underneath the limbs and foliage of the tree and around the trunk of the tree.

The system of the present invention may further include a ground sheet. The ground sheet is of a material which inhibits passage of the target insects through the sheet when the target insects come up from the ground under the tree penumbra when the ground sheet is laid on the ground underneath the tree, the ground sheet also inhibits insect larvae of the target insects passing through the ground sheet so as to reach the ground when falling from the tree to the ground. The ground sheet is adapted for mounting around the trunk of the tree so as to cover substantially the entire penumbra of the tree on the ground. In one embodiment the ground sheet is not opaque.

In a preferred embodiment the array of arms forms a cross and includes four arms. In a four arm embodiment each arm in the array of arms may form substantially a square in planform shape when the bag is laid flat and the array of arms are not mounted to one another along said side edges of the arms. The center portion may be substantially a square in planform when laid flat. The resulting three dimensional container is substantially cubic when said side edges of said array of arms are mounted to one another.

In one embodiment an oppositely disposed first pair of arms of the four arms and the center portion disposed between the first pair of arms collectively are formed of a single rectangular sheet of said mesh material. In that embodiment an oppositely disposed second pair of arms of the four arms are a pair of separate sheets of the mesh material mounted to the single rectangular sheet so as to form the cross.

In a further embodiment at least one flexible strap is mounted at a first end thereof adjacent the center portion so as to hang freely inside said three dimensional container adjacent a corresponding side thereof. A second end of at least one flexible strap, opposite the first end, depends downwardly from the first end. A means is provided for releasably securing the strap under the corresponding side of the bag so as to form a loop under and between the first and second ends and so as to releasably secure the second end to an exterior of the bag when the corresponding side of the bag is gathered upwardly from a free-hanging downwardly disposed position into a stored position compactly stored in the loop. The bag is thereby mountable onto the tree by passing the corresponding side, in its stored position, over the tree. Once mounted on the tree the corresponding side is then returned to the free-banging downwardly disposed by releasing of the means for releasably securing at least one strap.

Advantageously, the means for releasably securing at least one strap is a hook and look fastener cooperating between at least one strap and the exterior of the bag. The at least one strap may be at least one length of ribbon, for example so as to include a pair of parallel ribbons mounted at the first ends thereof in spaced apart parallel array adjacent an intersection of the center portion and the corresponding side. A first cooperating element of the hook and loop fastener may be mounted along each of the pair of ribbons. A second cooperating element of the hook and loop fastener, cooperating in releasable mating engagement with the first cooperating element, may be mounted adjacent said intersection on said exterior surface of said bag.

A method of using the system according to the present invention may include the consecutive steps of:
a) mounting the ground sheet around the trunk of the tree so as to lay on the ground and so as to cover at least the penumbra of the tree, wherein the mounting of the ground sheet is done during a stage in a life cycle of the target insect before the target insect emerges from the ground as an adult and flies into the tree;
b) leaving the foliage of the tree uncovered by the bag during pollination of the tree;
c) covering the foliage of the tree with the bag following pollination of the tree and before ripening of fruit on the tree or the target insect emerging from the ground, whichever occurs first, and leaving the bag on the tree foliage at least until picking of any fruit from the tree commences:
d) removing the bag from the tree or untying the base of the bag when on the tree so as to allow picking of the fruit on the tree;
e) removing the ground sheet from around the trunk of the tree.

### BRIEF DESCRIPTION OF THE DRAWINGS

FIG. 1 is, in perspective view, an embodiment of the insect control system according to the present invention mounted on a tree.

FIG. 2 is, in plan view, the bag of the system of FIG. 1 laid flat.

FIG. 3 is, in perspective view, the bag of the system of FIG. 1.

FIG. 4 is, in plan view, the bag of the system of FIG. 1 laid flat.

FIG. 5 is, in plan view, a further embodiment of the bag of the system in FIG. 1 according to the present invention laid flat.

FIG. 6 is, in perspective view, the bag of FIG. 5.

FIG. 7 is, in perspective view, the bag of FIG. 5.

### DETAILED DESCRIPTION OF EMBODIMENTS OF THE INVENTION

The apparatus of the present invention is a system for reducing or minimizing the damage to fruit and vegetable crops which occurs as a result of insects attacking the fruit or vegetables prior to it being harvested.

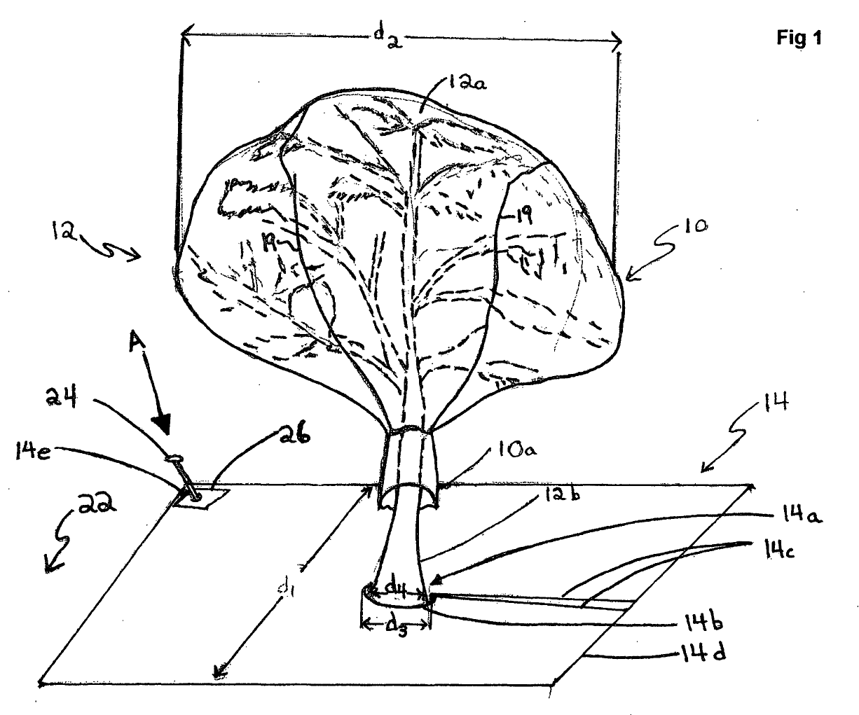

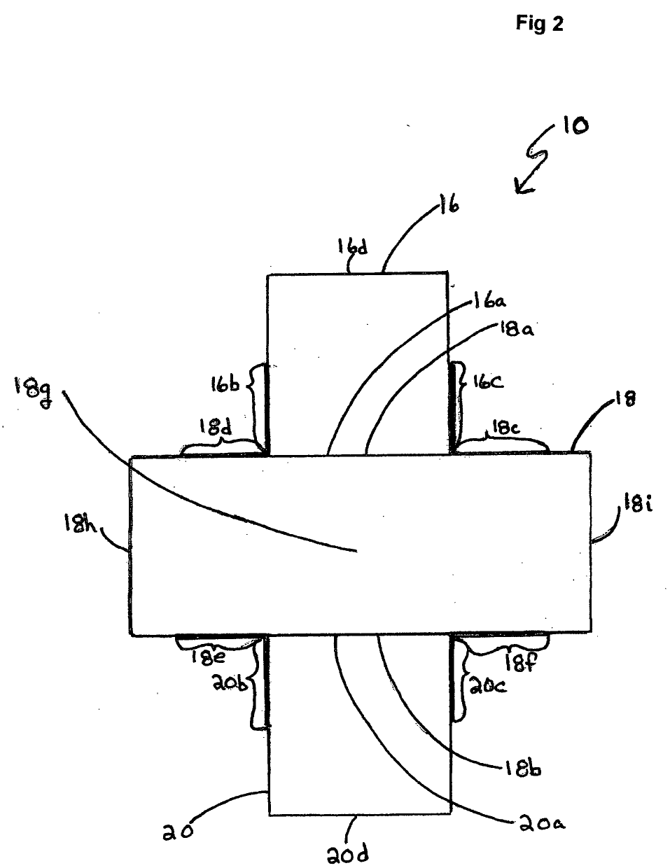

Without intending to be limiting, FIGS. 1-4, wherein like reference numerals denote corresponding parts in each view, illustrate an embodiment of the present invention wherein bag 10 is placed over tree 12. Bag 10 is made of any suitable porous, pliable material such as, without intending to be limiting, “no-see-um” or mosquito netting. Bag 10 may be assembled by attaching together a plurality of pieces of such suitable porous, pliable material so as to form a cross (+) shape as seen in FIG. 2. The material for bag 10 should be sufficiently sheer such that when bag 10 is placed over tree 12, light can penetrate bag 10 and shine on the leaves on tree 12 while at the same time the material must have a mesh or weave which is sufficiently fine so as to keep out the target insects.

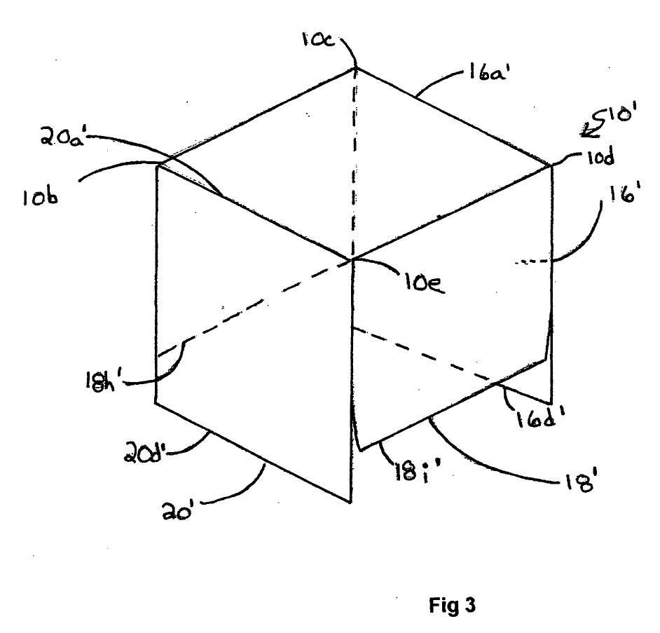

Without intending to be limiting, individual bag pieces 16, 18 and 20 may be respectively formed by attaching together two or more pieces of a suitable material by any suitable means of attachment such as, without intending to be limiting, sewing. Pieces 16 and 18 are joined together at abutting edges 16a and 18a to form seam 19. Collectively, such seams are referred to herein by reference numeral 19. Pieces 18 and 20 are joined together at abutting edges 18b and 20a. Sections 16c and 16b of bag piece 16 are then joined to corresponding sections 18c and 18d, respectively, of bag piece 18. Sections 20b and 20c of bag piece 20 are then attached to corresponding sections 18e and 18f, respectively, of bag piece 18. Any suitable means of attachment such as, without intending to be limiting, sewing, may be utilized to so join sections 16, 18 and 20. The joining together of bag pieces 16, 18 and 20 in the manner aforesaid, results in one embodiment in a cube-shaped bag 10 as illustrated in FIG. 3.

Bag 10 is then placed over tree 12 such that centre point 18g of bag 18 is roughly situated at the vertex or top 12a of tree 12. Tree 12 may thus be substantially encased by bag 10. Any suitable means may be used to place bag 10 over tree 12 as, for example, by utilizing three or four people using long poles fitted with cushioned end pieces so as to not tear bag 10 are placed on inside corners 10b, 10c, 10d and 10e of bag 10 to lift edges 16d, 18h, 18i and 20d up and over tree 12. Advantageously, the upper ends of the poles may be placed into the upper corners of the bag, that is the upper corners of the cube-shape bag of FIG. 3. Once bag 10 has been placed over tree 12, bag 10 may be secured at its lower or open end 10a to tree trunk 12b by any suitable means such as tying a rope around bag open end 10a and tree trunk 12b, or sewing or tying ends 16d, 18h, 18i and 20d of bag 10 together around tree trunk 12b. This will inhibit the unintended dislodgement of bag 10 from tree 12. When it is time to pick the fruit, bag 10 can be left in place until the harvesting has been completed, or may be removed prior to picking and stored for reuse. Bag 10 may, without intending to be limiting, be removed by two or more people using poles. The people may, for example, position themselves under bag 10 and use poles to lift bag 10 up and off of tree 12 or, alternatively, may stand outside of bag 10, grasp at least one edge of bag 10 such as edge 20c and pull bag 10 away from and off of tree 12.

The dimensions of bag 10 should be appropriate to the size of the tree or plant to be covered. For example, without intending to be limiting, to cover a tree 12 which is approximately 15 feet tall and 18 feet wide, bag 10 may have the following dimensions:

| | |
|---|---|
| Length d₅ of bag piece 18: | 50 feet |
| Width d₆ of bag piece 18: | 20 feet |
| Length d₈ of bag piece 16: | 20 feet |
| Width d₇ of bag piece 16: | 20 feet |
| Length d₉ of bag section 16b: | 10 feet |
| Length d₁₁ of bag section 18c: | 10 feet |
| Length d₁₀ of bag section 18j: | 15 feet |
| Length d₁₃ of bag section 20: | 20 feet |
| Width d₁₂ of bag section 20: | 20 feet |
| Length d₁₅ of bag section 18f: | 10 feet |
| Length d₁₄ of bag section 20b: | 10 feet |

Once placed over tree 12 and secured around tree trunk 12b, bag 10 will hinder or prevent adult flies from flying into the foliage of tree 12 and any fruit growing thereon.

To deter and interrupt the life cycle of insects such as the cherry tree flies described above which spend a portion of their life cycles in or on the ground situated beneath a crop bearing plant, ground cover 14 may be used independently or in conjunction with bag 10. Ground cover 14 should be at least one sheet made of a suitable transparent or translucent material such as, without intending to be limiting, clear plastic, mosquito netting or “no-see-um” netting. If netting is used, it should have a weave or mesh which is sufficiently fine so as to prevent the target insects from passing through it. Ground cover 14 may be of any suitable shape provided that at its narrowest diameter d₁ of ground cover 14 should approximate the greatest width of the tree, that is diameter d₂ of tree 12, and preferably exceed diameter d₂ by, for example, at least three to ten feet (both collectively referred to herein as the tree penumbra) so as to allow for the wind-blown trajectory of any larvae falling from tree 12. Ground cover 14 may be made of at least one piece of suitable material.

To facilitate placement of ground cover 14 around trunk 12b of tree 12, a hole 14a may be cut in or near the centre of ground cover 14. Diameter d₃ of ground cover hole 14a should be the same as or slightly larger than diameter d₄ of tree trunk 12b such that there is minimal or no gap between tree trunk 12b and ground cover 14 at ground cover hole edge 14b. A slit may then be cut into ground cover 14 from ground cover hole edge 14b to outer edge 14d of ground cover 14 to form slit edges 14c to facilitate placement of ground cover 14 around tree trunk 12b. Ground cover slit edges 14c should overlap so that no ground 22 is visible between slit edges 14c. Alternatively, ground cover 14 may be comprised of two or more pieces which, when assembled, create ground cover hole 14a to encircle tree trunk 12b such that ground cover hole 14a snugly abuts tree trunk 12b and diameter d1 of ground cover should approximate the tree penumbra so as to allow for the wind-blown trajectory of any larvae falling from tree 12. Ground cover 14 may be secured to ground 22 by any suitable means of attachment 24 such as, without intending to be limiting, nails or spikes. To affix ground cover 14 to ground 22, attachment means 24 may be driven through ground cover 14 into ground 22 by means of suitable pressure being applied in direction A onto the top of attachment means 24. If ground cover 14 is made of a waterproof material such as plastic, the attachment means 24 may be made of a hollow, perforated material such as PVC which could provide a means of drainage for water accumulating on ground cover 14. To reduce the likelihood of ground cover 14 tearing at point 14e where it is affixed to ground 22 by attachment means 24, a piece of tear-resistant material 26 such as, without intending to be limiting, heavy plastic or cardboard, could be placed between attachment means 24 and ground cover 14.

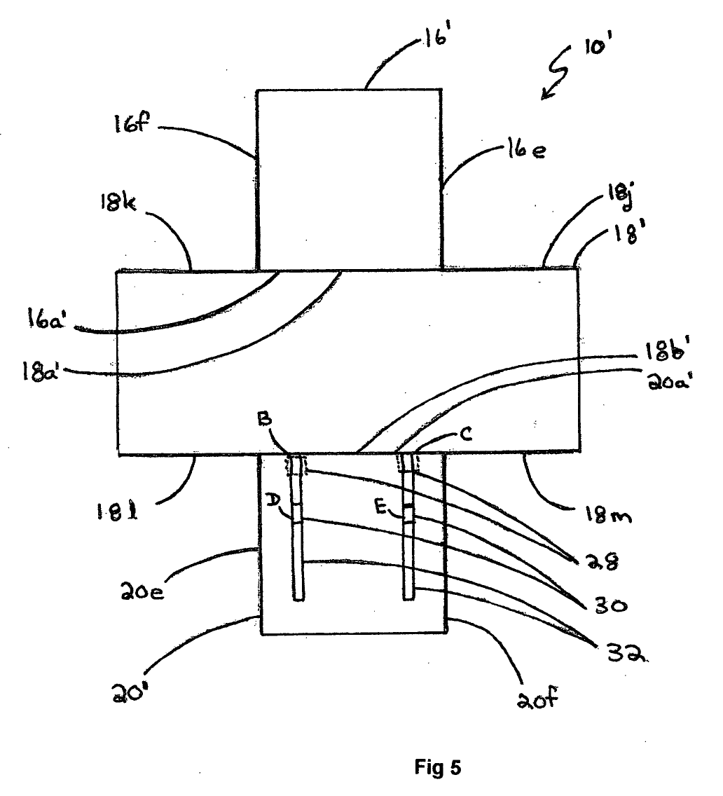

An alternative embodiment of the present invention is seen in FIGS. 5 to 7. Again, like reference numerals denote corresponding parts in each view. Pieces 16′ and 18′ are joined together at abutting edges 16a′ and 118a′. The uppermost edges B and C of ribbons 32 are placed between the abutting edges 18b′ and 20′ of pieces 18′ and 20′, and pieces 18′ and 20′ are joined together with ribbons 32 at abutting edges 18b′ and 20a′. Male (looped) velcro pieces 30 are then placed on top of ribbons 32 at points D and E and attached to ribbons 32 such as by, without intending to be limiting, sewing around the perimeter of each velcro tab 30. Corresponding female (hooked) velcro tabs 28 are attached, by any suitable means, to the reverse side of bag piece 20′ at points B and C. Such as by, without intending to be limiting, sewing around the perimeters of velcro tabs 28 such that velcro tabs 28, the portion of bag piece 20′ lying between velcro tabs 28 and ribbons 32, and the corresponding parts of ribbon 32 are thusly joined together.

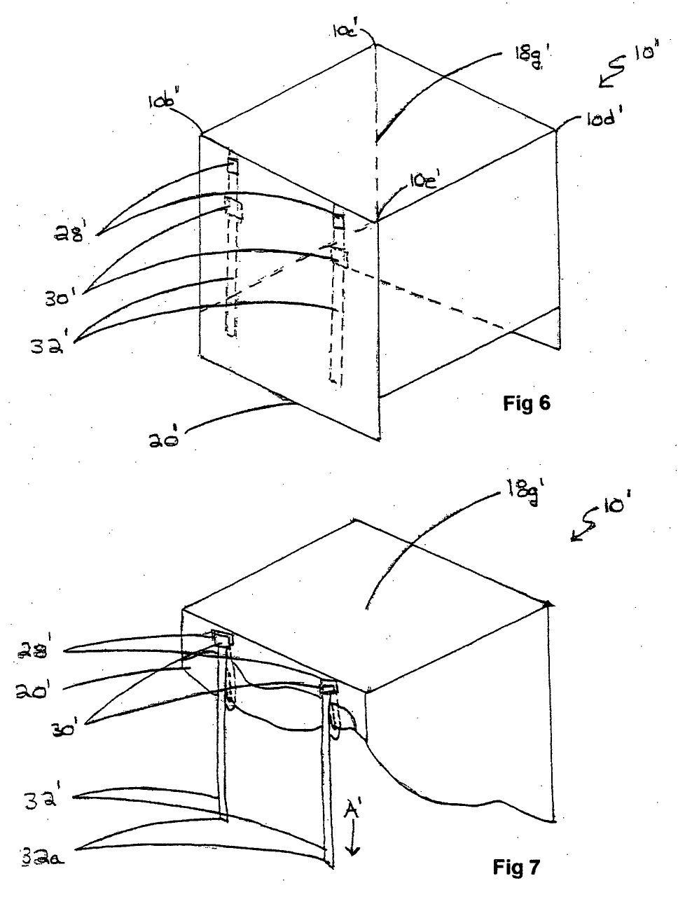

Bag piece edge 18j is then joined to corresponding bag piece edge 16e, and edge 18k is joined to edge 16f. Bag piece 181 is then joined to corresponding bag piece edge 20e, and edge 18m is joined to edge 20f. As edges 16e, 16f, 20e and 20f are longer than corresponding edges 18j, 18k, 181 and 18m, a portion of each of bag pieces 16′ and 20′ will extend beyond their respective joinders with bag piece 18′ as illustrated in FIG. 6.

As is illustrated in FIG. 7, prior to placing bag 10′ over tree 12, bag piece 20′ material is gathered on top of ribbons 32′ such that velcro tabs 30′ may be mated with their corresponding counterparts, velcro tabs 28′. Any suitable means may be used to urge or place bag 10 over tree 12 such as, without intending to be limiting, by the use of long poles fitted with cushioned end pieces so as to not tear bag 10 in each of bag corners 10b′, 10c′, 10d′ and 10e′, to lift bag 10′ up and over tree 12. Once centre point 18e′ of bag 10′ is roughly situated at the top 12a of tree 12, ribbons 32′ may be grasped at ends 32a and pressure applied downwardly in direction A′ thereby causing velcro tabs 28′ and 30′ to disconnect and allowing bag piece 20′ to drop down for securing around tree trunk 12b.

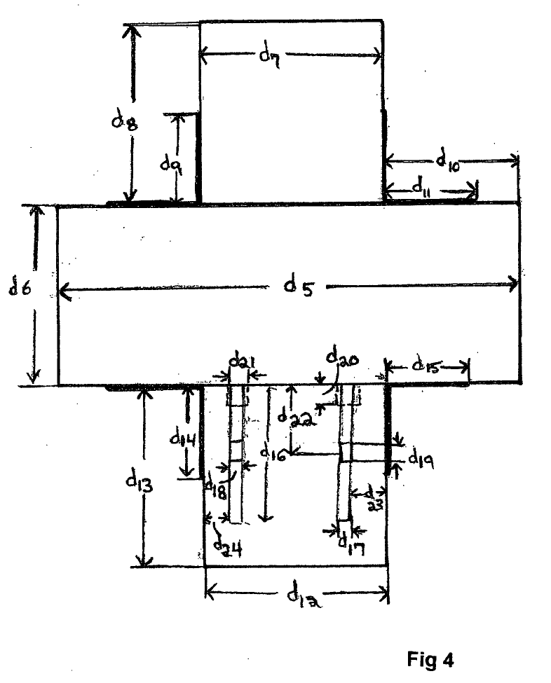

Without intending to be limiting, ribbons 32, velcro tabs 28 and 30 and the placement of the same on bag section 20 may have the following dimensions as illustrated in FIG. 4:

| | | |
|---|---|---|
| Length d₁₆ of ribbons 32: | 12 | feet |
| Width d₁₇ of ribbons 32: | 1.5 | inches |
| Length d₂₀ of velcro tabs 28: | 3.5 | inches |
| Width d₂₁ of velcro tabs 28: | 2.0 | inches |
| Length d₁₉ of velcro tabs 30: | 3.5 | inches |
| Width d₁₈ of velcro tabs 30: | 2.0 | inches |
| Distance d₂₂: | 18 | inches |
| Distance d₂₃: | 30 | inches |
| Distance d₂₄: | 30 | inches |

Utilization of the bag and ground cover of the present invention either alone or in conjunction with each other may interrupt the life cycle of certain insects which attack fruit or vegetable crops to a sufficient degree that the resultant damage to the crops is either significantly reduced or eliminated. Consistent usage of the method and apparatus of the present invention may also substantially eliminate the existence of problem insects in the area near, on and around the crop bearing plant. For example, without intending to be limiting, in the instance of a cherry tree which has been infested by cherry fruit flies, the bag and ground cover of the present invention may be utilized either alone or in conjunction to minimize or eliminate damage to the developing cherry crop. As noted above, where a cherry tree has been infested by the cherry fruit fly, eggs hatch in the developing cherry fruit and, once fully developed, the larvae bore out of the cherry and drop to the ground beneath the cherry tree. Shortly after falling to the ground, the larvae burrow into the ground to pupate and remain in the soil over the winter. The larvae pupate over winter and emerge from the ground as adult flies in the spring, which adults then fly up into the cherry tree to lay eggs in the developing cherries.

To interrupt the life cycle of the cherry fruit fly, ground cover 14 may be placed beneath the infested tree in early spring, well prior to the earliest date on which the first adult cherry flies are likely to emerge. Access to the cherry tree will be inhibited by ground cover 14 such that the majority of the emerging adult cherry flies, unable to escape the confines of ground cover 14 or to reach the developing cherries, will perish under ground cover 14 without laying eggs. Leaving ground cover 14 in place until all of the fruit on the tree has been picked will enable it to serve a further function. The presence of ground cover 14 on the ground beneath the subject tree will function as a barrier between any cherry fruit fly larvae falling from fruit on the tree to the ground beneath the tree, thereby interfering with the larvae's access to that ground. Accumulating larvae may be collected as required from the surface of ground cover 14. Ground cover 14 may be removed once all of the fruit is off of the tree. Ground cover 14 may therefore interrupt the cherry fruit fly's life cycle both at the larvae to adult stage and again, for any new larvae which develop in the fruit grown by the subject tree, by preventing such larvae from accessing the ground which they require in order to survive the winter and to pupate.

Where no ground cover 14 is used or as an additional protective measure, bag 10 may also be used. Bag 10 should be placed over tree 12 once fruit has pollinated but prior to the cherry fruit fly laying its eggs. Without intending to be limiting, to establish an indicator as to the appropriate time to place bag 10 on tree 12, Safer's Sticky Strips or a similar product may be hung on the subject tree. Once the first fruit fly is seen on the strip, bag 10 should be placed over tree 12. The barrier created by bag 10 will inhibit or prevent adult fruit flies from accessing the fruit developing on the tree thereby preventing the adult flies from laying eggs in or on that fruit. The likelihood of the fruit being infested with fruit fly larvae is therefore significantly reduced. This translates to a reduction in the number of fruit fly larvae which can develop while at the same time preserving the quality of the developing fruit.

Bag 10 may be left in place while the fruit is being harvested from tree 12. To leave in place while picking, bag 10 may be opened or untied at its base 10a. If picking is not completed in one day as, for example, in the case of inclement weather or of all of the fruit not ripening at the same time, bag 10 can simply be re-secured around tree trunk 12b, thereby maintaining the barrier between the ripened or ripening fruit and outside pests until picking can be completed. Leaving bag 10 in place while picking may also increase the comfort level of the pickers by hindering insects such as mosquitos from attacking the pickers. Alternatively, if it is desired that the fruit be allowed to ripen and dry on the tree, bag 10 may be left in place, again functioning to hinder pests from attacking the fruit. In the further alternative, if the pickers so desire, bag 10 can be removed at picking time and stored away for future use. In either instance, whether the bag is opened or removed entirely for picking of the fruit, the use of the ground sheet (cover 14) catches dropping insect pupae while access to the tree is required for the picking.

As adult cherry fruit flies do not fly long distances, use of ground cover and bag 10, either alone or in conjunction, offer at least three potential opportunities to interrupt the life cycle of the cherry fruit fly. Ground cover 14 may trap the majority of adult fruit flies emerging beneath it thereby preventing them from accessing the fruit they require to survive and to propagate. Utilization of a bag of the present invention on a tree will inhibit any adult fruit flies which escape ground barrier 14 or arrive from a neighbouring tree from accessing the protected tree and fruit growing thereon. Should any cherry fruit fly larvae develop in the fruit, the presence of ground cover 14 on the ground beneath the tree will serve a further purpose, namely, preventing the cherry fruit fly larvae from reaching the ground below. Hence, utilization of the bag and ground cover apparatus of the present invention, either alone or in conjunction, offer a chemical free means and method for interrupting the life cycle of insects such as, without intending to be limiting, the cherry fruit fly, and the attendant damage such insects cause to developing crops.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. An insect control system for mounting on a tree to control infestation of the tree by target insects, the system comprising:
a tree foliage containment bag,
wherein said bag is of porous flexible mesh material having apertures smaller than said target insects to inhibit passage of said target insects through said mesh,
wherein said bag, when laid flat, in planform is shaped to include a radially spaced apart array of planar arms extending from a center portion, said center portion corresponding to a top portion of said bag once assembled and mounted atop the tree, said array of arms corresponding to side portions of said bag once assembled and mounted so as to cover sides of the tree, wherein said arms each include side edges therealong whereby, opposed obliquely facing side edges on adjacent pairs of said arms are mountable to each other to form a closed seam along and between each of said pairs of said arms, whereby said bag is formed as a flexible porous three dimensional container mountable over the tree so as to substantially entirely cover the limbs and foliage of the tree,
means for securing lower edges of said array of arms when mounted on the tree underneath said limbs and foliage of the tree and around a trunk of the tree.

2. The system of claim 1 further comprising a ground sheet, wherein said ground sheet is of a material which inhibits passage of the target insects through said sheet when the target insects come up from the ground under the tree penumbra when said ground sheet is laid on the ground underneath the tree and which inhibits passage of insect larvae of the target insects to the ground when falling from the tree to the ground, wherein said ground sheet is adapted for mounting around the trunk of the tree so as to cover substantially the entire penumbra of the tree on the ground.

3. The system of claim 2 wherein said ground sheet is not opaque.

4. The system of claim 1 wherein said array of arms forms a cross and comprises four arms.

5. The system of claim 4 wherein each said arm in said array of arms forms substantially a square in planform shape when said bag is laid flat and said array of arms are not mounted to one another along said side edges of said arms.

6. The system of claim 5 wherein said center portion is substantially a square in planform when laid flat.

7. The system of claim 6 wherein said three dimensional container is substantially cubic when said side edges of said array of arms are mounted to one another.

8. The system of claim 7 wherein an oppositely disposed first pair of arms of said four arms and said center portion disposed between said first pair of arms collectively are formed of a single sheet of said mesh material.

9. The system of claim 8 wherein an oppositely disposed second pair of arms of said four arms are a pair of separate sheets of said mesh material mounted to said single sheet so as to form said cross.

10. The system of claim 1 further comprising at least one flexible strap mounted at a first end thereof adjacent said center portion so as to hang freely inside said three dimensional container adjacent a corresponding side thereof and so that a second end of said at least one flexible strap, opposite said first end, depends downwardly from said first end, a means for releasably securing said strap under said corresponding side of said bag so as to form a loop under and between said first and second ends and so as to releasably secure said second end to an exterior of said bag when said corresponding side of said bag is gathered upwardly from a free-hanging downwardly disposed position into a stored position compactly stored in said loop, whereby said bag is thereby mountable onto the tree by passing said corresponding side in said stored position over the tree, and said corresponding side then returned to said free-hanging downwardly disposed position once said bag is mounted over the tree by releasing of said means for releasably securing said at least one strap.

11. The system of claim 10 wherein said means for releasably securing said at least one strap is a hook and look fastener cooperating between said at least one strap and said exterior of said bag, and wherein said at least one strap is at least one length of ribbon.

12. The system of claim 11 wherein said at least one length of ribbon includes a pair of parallel ribbons mounted at said first ends thereof in spaced apart parallel array adjacent an intersection of said center portion and said corresponding side.

13. The system of claim 12 wherein a first cooperating element of said hook and loop fastener is mounted along each of said pair of said ribbons, and wherein a second cooperating element of said hook and loop fastener, cooperating in releasable mating engagement with said first cooperating element, is mounted adjacent said intersection on said exterior surface of said bag.

14. In insect control system for mounting on a tree to control infestation of the tree by target insects, wherein the system includes:
a tree foliage containment bag,
wherein said bag is of porous flexible mesh material having apertures smaller than said target insects to inhibit passage of said target insects through said mesh,
wherein said bag, when laid flat, in planform is shaped to include a radially spaced apart array of planar arms extending from a center portion, said outer portion corresponding to a top portion of said bag once assembled and mounted atop the tree, said array of arms corresponding to side portions of said bag once assembled and mounted so as to cover sides of the tree, wherein said arms each include side edges therealong whereby, opposed obliquely facing side edges on adjacent pairs of said arms are mountable to each other to form a closed seam along and between each of said pairs of said arms, whereby said bag is formed as a flexible porous three dimensional container mountable over the tree so as to substantially entirely cover the limbs and foliage of the tree,
means for securing lower edges of said array of arms when mounted on the tree underneath said limbs and foliage of the tree and around a trunk of the tree, and
a ground sheet, wherein said ground sheet is of a material which inhibits passage of the target insects through said sheet when the target insects come up from the ground under the tree penumbra when said ground sheet is laid on the ground underneath the tree and which inhibits passage of insect pupae of the target insects to the ground when falling from the tree to the ground, wherein said ground sheet is adapted for mounting around the trunk of the tree so as to cover substantially the entire penumbra of the tree on the ground;
a method of using said system comprising the consecutive steps of:
a) mounting said ground sheet around the trunk of the tree so as to lay on the ground and so as to cover at least the penumbra of the tree, wherein said mounting of said ground sheet is done during a stage in a life cycle of the target insect before the target insect emerges from the ground and flies into the tree;
b) leaving the foliage of the tree uncovered by said bag during pollination of the tree;
c) covering the foliage of the tree with said bag following pollination of the tree and before ripening of fruit on the tree, and leaving the bag on the tree foliage at least until picking of any fruit from the tree commences;
d) removing said bag from the tree or untying the base of the bag when on the tree so as to allow picking of the fruit on the tree;
e) removing said ground sheet from around the trunk of the tree.
